(19) United States
(12) Patent Application Publication
(10) Pub. No.: US 2007/0097449 A1
(43) Pub. Date: May 3, 2007

(54) Image forming device

(76) Inventor: Yukio Shibata, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/259,149

(22) Filed: Oct. 27, 2005

(51) Int. Cl. G06F 15/00

(52) U.S. Cl. 358/406; 358/1.9

(57) ABSTRACT

The present invention is an image forming device, wherein, if a print instruction is received during calibration, then the user is informed to the effect that they should determine the priority order of the calibration and the print command, and that user instruction determines the priority order. If the priority of the print command is higher than the calibration, then calibration is interrupted and the print command is executed.

### FIELD OF THE INVENTION

The present invention relates to an image forming device, such as a copying machine, a multifunction machine, and a printer.

### BACKGROUND INFORMATION

In recent years, there has been a rapid popularization in the use of image forming devices, such as copying machines, multifunction machines, and printers, in offices and homes. These image forming devices are sometimes used as standalones, and are sometimes connected by wired and wireless networks to data communications terminals, such as personal computers and mobile telephones.

FIG. 4 is a schematic drawing of an image forming device 40, which comprises a touch panel 11 for a user to input a print command.

In addition, FIG. 5 is a schematic view of a common image forming system, wherein a user can execute a desired printing by sending a print command from a personal computer 42, a mobile telephone 43, and the like, to the image forming device 40.

Incidentally, in such an image forming device 40, distortions of the image formed may arise due to changes in the environment (e.g., temperature and humidity), changes in the voltage when printing, and the like. To overcome these problems, the image forming device normally performs a variety of calibrations (automatic compensation) periodically at a rate of, for example, once every hundredth printing or once every five hours. Concrete examples of such calibrations are already known in the art.

Accordingly, a typical example of a calibration is the detection of a drop in the toner concentration by forming a reference pattern outside of the image forming area of a photoreceptor, and optically reading the pattern.

Various other calibrations are also performed and these procedures normally take from one to several minutes; if a print command is input during this time, then the print command transitions to a wait state. Consequently, techniques to notify the user that the print command is in a wait state are already known in the art.

In addition, it is known in the art to notify a user of the time needed between cancellation of a wait state and actual completion of printing.

However, these techniques have the problems mentioned below.

Not much attention may be paid to calibration when actually using an image forming device. For example, it may not matter if there is some distortion of the image when printing a document image consisting of characters rather than of an image, such as a photograph or a drawing.

With these techniques, there is only a method in which the user just stands by until calibration is completed. However, with the printing of a document that is urgently needed, and the like, it is conceivable that [the user] will want to temporarily suspend calibration and give priority to printing the relevant document.

The present invention considers such problems; an object of the present invention is to provide an image forming device wherein, if there is a print command during calibration, then the user can select the priority order of the calibration and the print command.

### SUMMARY OF THE INVENTION

To solve the abovementioned problems, the present invention adopts the following means.

The present invention uses a determining means that, if a print command is received during calibration, determines a priority order of the calibration and the print command; and a controlling means that controls the execution of the calibration and the print command in accordance with the determined priority order. The determination of the priority order is judged based on the instruction of the user, the progress status of the calibration, the urgency level of the calibration, and the like.

Based on the above, if a print command is received during calibration, the user can select the priority order of the calibration and the print command.

### BRIEF DESCRIPTION OF THE DRAWINGS

FIG. 1 is a block diagram of the image forming device of the present invention.

FIG. 2 is an example of a message displayed to the user.

FIG. 3 is a block diagram of the image forming device of the present invention.

FIG. 4 is a schematic drawing of a common image forming device.

FIG. 5 is a schematic drawing of a common image forming system.

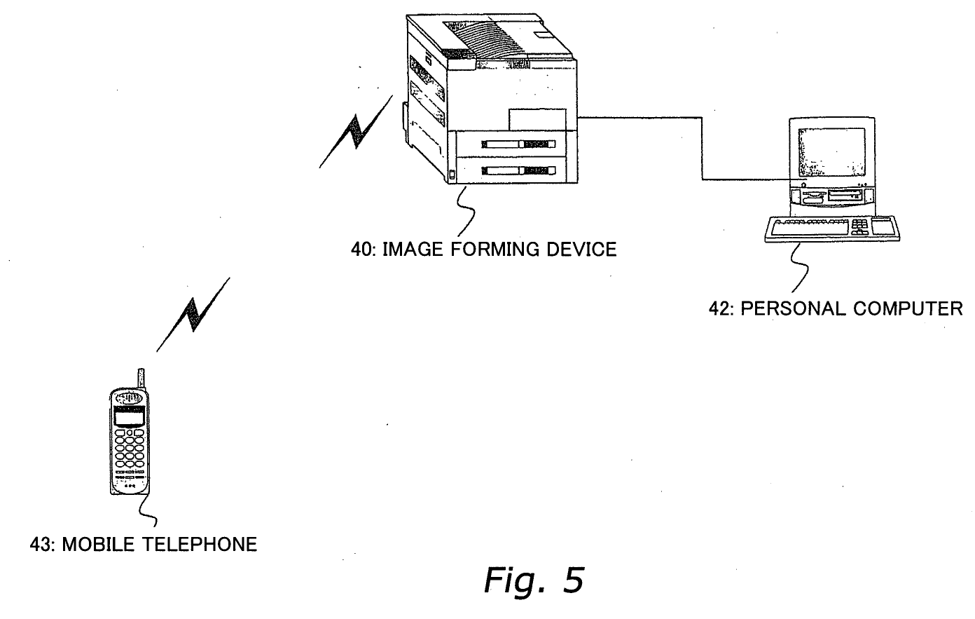

### DETAILED DESCRIPTION OF THE PREFERRED EMBODIMENTS

### First Embodiment

The following is a detailed description of the preferred embodiments of the present invention, referencing the drawings.

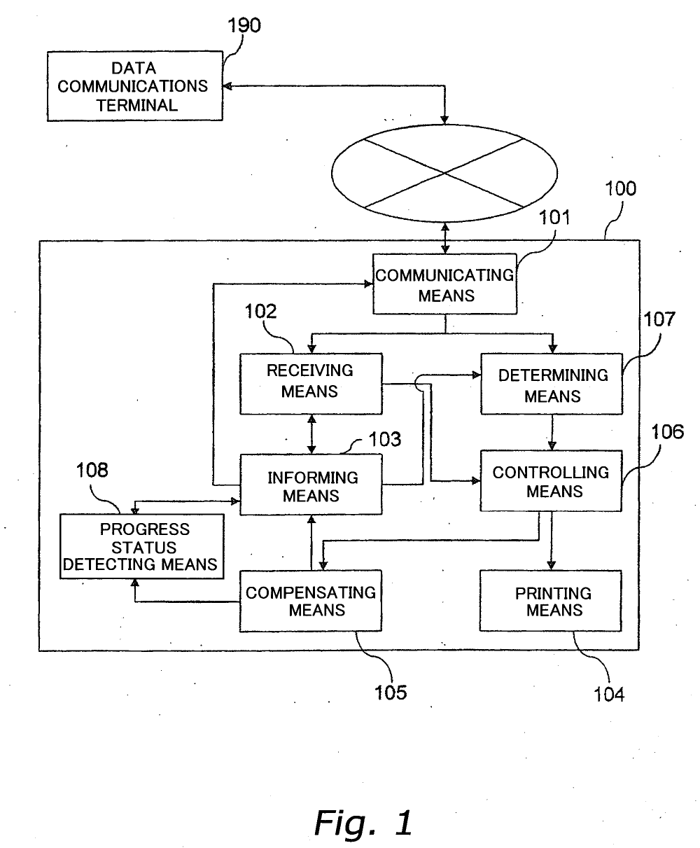

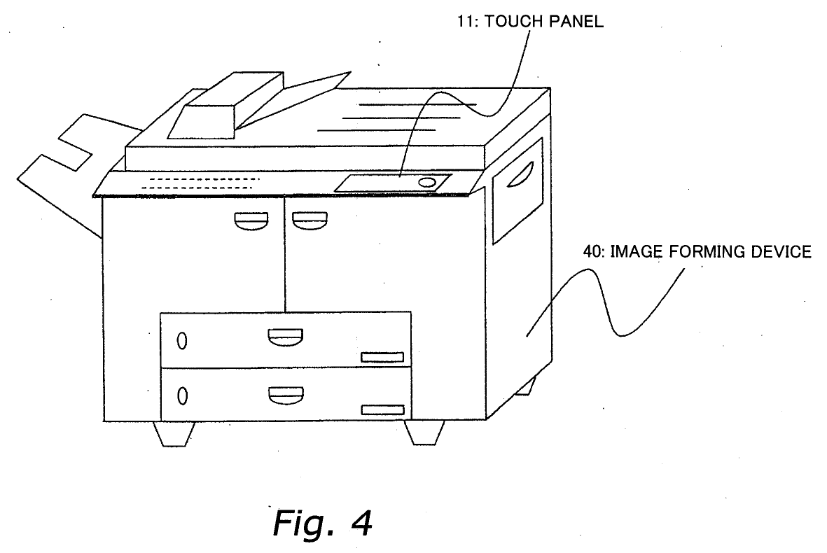

FIG. 1 is a block diagram of an image forming device 100 of the present embodiment. FIG. 4 is a schematic drawing of this image forming device 100. A controlling means 106 controls the operation of a printing means 104 and a compensating means 105. The compensating means 105 performs various calibrations (automatic compensation). The controlling means 106 suspends the operation of the printing means 104 during this calibration, and suspends calibration by the compensating means 105 when the printing means 104 is printing.

The image forming device 100 comprises a communicating means 101 that communicates with a data communications terminal 190, such as a personal computer connected to a network like a LAN (local area network). Accordingly, the user of the data communications terminal 190 can transmit a print command from the data communications terminal 190 to the image forming device 100.

First, the print command transmitted from the data communications terminal 190 is received by the communicating means 101, and is then inputted into a receiving means 102. When a print command is inputted, the receiving means 102 notifies an informing means 103 to the effect that a print command was received. If notified to the effect that a print command was received, the informing means 103 judges whether calibration is presently being performed by the compensating means 105.

If it is judged that calibration is being performed, then the informing means 103 inquires with a progress status detecting means 108 for the progress status of the calibration. If there is an inquiry, the progress status detecting means 108 notifies the informing means 103 of, for example, the time until calibration will be completed, the completion percentage of the entire calibration, and the like. Furthermore, with the present embodiment, the progress status detecting means 108 notifies the informing means 103 of the time until calibration will be completed.

If notified of the time until completion, the informing means 103 informs the data communications terminal 190, via the communicating means 101 and the network, of the notified time and makes a request regarding the determination of the priority order of the calibration and the print command.

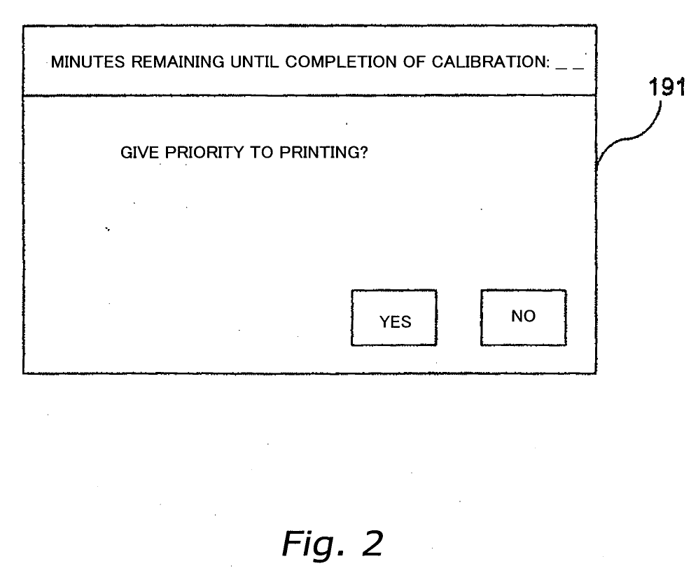

The data communications terminal 190 displays the time needed until the completion of calibration and displays a request to determine the priority order on a monitor 191, as depicted in FIG. 2, if notified of such.

If informed of the time needed until the completion of calibration and of a request to determine the priority order, such are displayed on the monitor 191 of the data communications terminal 190, as depicted in FIG. 2.

If the time until completion of the calibration and a request to determine the priority order are displayed on the monitor 191 of the information communications terminal 190, then the user decides which to perform first—the calibration or the print command—by considering the time until completion of calibration. After the user decides which to perform first, the user inputs the priority order of the calibration and the print command into the data communications terminal 190 and transmits the priority order to the image forming device 100 via the network. Furthermore, with the present embodiment, the user selects YES in FIG. 2 if he or she decides that the print command should be performed first, and selects NO in FIG. 2 if he or she decides that calibration should be performed first.

When the priority order is transmitted, the communicating means 101 inputs the received priority order into a determining means 107. When the priority order is inputted, the determining means 107 determines such as the priority order, and inputs the determined priority order into the controlling means 106.

If the inputted priority order indicates that the priority of the calibration is higher than the print command, then the controlling means 106 causes the compensating means 105 to execute that calibration until it is completed, and, when that calibration is completed, [the controlling means 106] acquires the print command from the receiving means 101 and causes the printing means 104 to execute it.

However, if the inputted priority order indicates that the priority of the print command is higher than the calibration, then the controlling means 106 interrupts the calibration being executed in the compensating means 105, acquires the print command from the receiving means 101, and causes the printing means 104 to execute it. If the print command is completed, the controlling means 106 causes the executing means 105 to execute the interrupted calibration.

It is possible, if the printing of a document is needed urgently, to immediately print the relevant document by executing the print command first because, as described above, the user can select whether to execute calibration or the print command first.

In addition, if it is judged that calibration is not being performed when a print command has been inputted from the data communications terminal 190 to the receiving means 102, then the informing means 103 notifies the receiving means 102 that calibration is not being performed. If notification is given that calibration is not being performed, then the receiving means 102 inputs the received print command into the controlling means 106.

If a print command is inputted from the receiving means 102, then the controlling means 106 causes the printing means 104 to execute the received print command.

Consequently, the print command is executed immediately if a print command is received when calibration is not being executed.

### Second Embodiment

If a print command is received during calibration in the first embodiment, then the informing means 103 inquires with the user for the priority order of the calibration and the print command; however, if the progress of calibration is well underway, then the informing means 103 may determine that the priority order of calibration is higher than the print command without inquiring with the user for the priority order.

For example, if calibration is almost finished, or if notified by the progress status detecting means 108 that the progress status is such that calibration will finish in a few seconds, then the informing means 103 notifies the determining means 107 of the progress status without inquiring with the user for the priority order. If notified by the informing means 103 of the progress status, then the determining means 107 determines that the priority order of calibration is higher than the print command, and inputs this into the controlling means 106.

### Third Embodiment

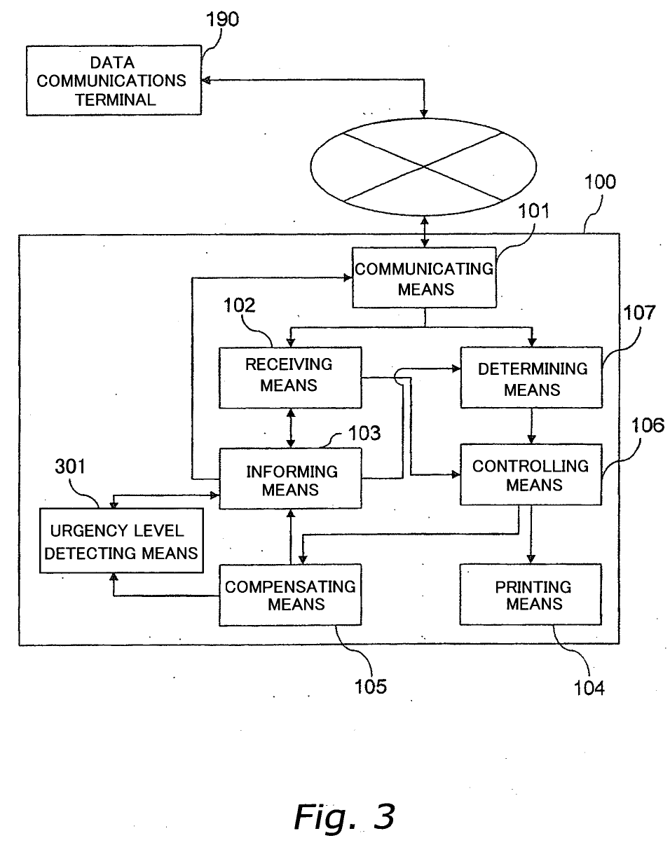

In the image forming device of the first and second embodiments, the progress status of calibration may be substituted by an urgency level of calibration. The urgency level is, for example, defined by how much a value, which is the target for judging whether to execute calibration, deviates from the normal value. If using an urgency level, then an urgency level detecting means 301, which detects the urgency level of calibration, is provided instead of the progress status detecting means 108 in the image forming device 100, as depicted in FIG. 3. This urgency level detecting means 301 detects the urgency level of calibration, for example, periodically.

If the urgency level is high, i.e., if the value, which is the target of the calibration, deviates greatly from the normal value, then the informing means 103 notifies the determining means 107 of the urgency level without inquiring with the user for the priority order. If notified of the urgency level by the informing means 103, then the determining means 107 determines that the priority of calibration is higher than the print command, and inputs this into the controlling means 106.

What is claimed is:

1. An image forming device, comprising:
a receiving means that receives a print command;
an informing means that, if a print command is received during calibration, informs a user to the effect that calibration is being executed;
a determining means that determines a priority order of the calibration and the print command based on an instruction from the user; and
a controlling means that controls the execution of the calibration and the print command in accordance with the determined priority order.

2. An image forming device as recited in claim 1, comprising:
a progress status detecting means that detects the progress status of the calibration; and
wherein the determining means determines the priority order of the calibration and the print command based also on the detected progress status.

3. An image forming device as recited in claim 1, comprising:
an urgency level detecting means that detects an urgency level of the calibration;
wherein the determining means detects the priority order of the calibration and the print command based also on the detected urgency level.
